(19) United States
(12) Patent Application Publication
(10) Pub. No.: US 2010/0161323 A1
(43) Pub. Date: Jun. 24, 2010

(54) AUDIO ENCODING DEVICE, AUDIO DECODING DEVICE, AND THEIR METHOD

(75) Inventor: Masahiro Oshikiri, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/298,404

(22) PCT Filed: Apr. 26, 2007
(86) PCT No.: PCT/JP2007/059091

§ 371 Date: Dec. 11, 2008

(30) Foreign Application Priority Data
Apr. 27, 2006 (JP) 2006-124175

(51) Int. Cl. G10L 11/04

(52) U.S. Cl. 704/207; 704/226; 704/E11.006

(57) ABSTRACT

Provided is an audio encoding device capable of preventing audio quality degradation of a decoded signal. In the audio encoding device, a noise analysis unit (118) analyzes a noise characteristic of a higher range of an input spectrum. A filter coefficient decision unit (119) decides a filter coefficient in accordance with the noise characteristic information from the noise characteristic analysis unit (118). A filtering unit (113) includes a multi-tap pitch filter for filtering a first-layer decoded spectrum according to a filter state set by a filter state setting unit (112), a pitch coefficient outputted from a pitch coefficient setting unit (115), and a filter coefficient outputted from the filter coefficient decision unit (119), and calculates an estimated spectrum of the input spectrum. An optimal pitch coefficient can be decided by the process of a closed loop formed by the filter unit (113), a search unit (114), and the pitch coefficient setting unit (115).

### TECHNICAL FIELD

The present invention relates to a speech coding apparatus, speech decoding apparatus, speech coding method and speech decoding method.

### BACKGROUND ART

To effectively utilize radio wave resources in a mobile communication system, compressing speech signals at a low bit rate is demanded. On the other hand, users expect to improve the quality of communication speech and implement communication services with high fidelity. To implement these, it is preferable not only to improve the quality of speech signals, but also to be capable of efficiently encoding signals other than speech, such as audio signals having a wider band.

To meet such contradictory demands, an approach of hierarchically combining a plurality of coding techniques is expected. To be more specific, studies are underway on a configuration combining in a layered manner the first layer for encoding an input signal at a low bit rate by a model suitable for a speech signal, and the second layer for encoding the residual signal between the input signal and the first layer decoded signal by a model suitable for signals other than speech signals. A coding scheme according to such a layered structure has a feature of scalability in bit streams acquired from the coding section. That is, the coding scheme has a feature that, even when part of bit streams is discarded, a decoded signal with certain quality can be acquired from the rest of bit streams, and is therefore referred to as “scalable coding.” Scalable coding having such feature can flexibly support communication between networks having different bit rates, and is therefore appropriate for a future network environment incorporating various networks by IP (Internet Protocol).

An example of conventional scalable coding techniques is disclosed in Non-Patent Document 1. Non-Patent document 1 discloses scalable coding using the technique standardized by moving picture experts group phase-4 (“MPEG-4”). To be more specific, in the first layer, code excited linear prediction (“CELP”) coding suitable for a speech signal is used, and, in the second layer, transform coding such as advanced audio coder (“AAC”) and transform domain weighted interleave vector quantization (“TwinVQ”), is used for the residual signal acquired by removing the first layer decoded signal from the original signal.

Further, as for transform coding, Non-Patent document 2 discloses a technique of encoding the higher band of a spectrum efficiently. Non-Patent Document 2 discloses using the higher band of a spectrum as an output signal of a pitch filter utilizing the lower band of the spectrum as the filter state of the pitch filter. Thus, by encoding filter information about a pitch filter with a small number of bits, it is possible to realize a lower bit rate.

Non-patent document 1: “Everything for MPEG-4 (first edition),” written by Miki Sukeichi, published by Kogyo Chosakai Publishing, Inc., Sep. 30, 1998, pages 126 to 127

Non-Patent Document 2: “Scalable speech coding method in 7/10/15 kHz band using band enhancement techniques by pitch filtering,” Acoustic Society of Japan, March 2004, pages 327 to 328

### DISCLOSURE OF INVENTION

### Problem to be Solved by the Invention

FIG. 1 illustrates the spectral characteristics of a speech signal. As shown in FIG. 1, a speech signal has a harmonic structure where peaks of the spectrum occur at fundamental frequency F0 and at the frequencies of integral multiples of F0. Non-Patent Document 2 discloses a technique of utilizing the lower band of a spectrum such as 0 to 4000 HZ band, as the filter state of a pitch filter and encoding the higher band of the spectrum such that the harmonic structure in the higher band such as 4000 to 7000 Hz band is maintained.

However, the harmonic structure of a speech signal tends to be attenuated at higher frequencies, since the harmonic structure of glottal excitation in the voiced part is attenuated more at higher frequencies. For such speech signal, in a method of efficiently encoding the higher band of a spectrum using the lower band of the spectrum as the filter state, the harmonic structure in the higher band is too significantly compared to the actual harmonic structure, and causes degradation of speech quality.

Further, FIG. 2 illustrates the spectrum characteristics of another speech signal. As shown in this figure, although a harmonic structure in the lower band exists, the harmonic structure in the higher band is lost for the most part. That is, this figure only shows noisy spectrum characteristics in the higher band. For example, in this figure, about 4500 Hz is the border at which the spectrum characteristics change. When a method of efficiently encoding the higher band of a spectrum using the lower band of the spectrum is applied to such speech signal, there are no enough noise components in the higher band, which may cause degradation of speech quality.

It is therefore an object of the present invention to provide a speech coding apparatus or the like that prevents sound quality degradation of a decoded signal upon efficiently encoding the higher band of the spectrum using the lower band of the spectrum even when the harmonic structure collapses in part of a speech signal.

### Means for Solving the Problem

The speech coding apparatus of the present invention employs a configuration having: a first coding section that encodes a lower band of an input signal and generates first encoded data; a first decoding section that decodes the first encoded data and generates a first decoded signal; a pitch filter that has a multitap configuration comprising a filter parameter for smoothing a harmonic structure; and a second coding section that sets a filter state of the pitch filter based on a spectrum of the first decoded signal and generates second encoded data by encoding a higher band of the input signal using the pitch filter.

### ADVANTAGEOUS EFFECT OF THE INVENTION

According to the present invention, it is possible to prevent sound quality degradation of a decoded signal upon efficiently encoding the higher band of the spectrum using the lower band of the spectrum even when the harmonic structure collapses in part of a speech signal.

### BRIEF DESCRIPTION OF DRAWINGS

FIG. 1 illustrates the spectrum characteristics of a speech signal;

FIG. 2 illustrates the spectrum characteristics of another speech signal;

FIG. 3 is a block diagram showing main components of a speech coding apparatus according to Embodiment 1 of the present invention;

FIG. 4 is a block diagram showing main components inside a second layer coding section according to Embodiment 1;

FIG. 5 illustrates filtering processing in detail;

FIG. 6 is a block diagram showing main components of a speech decoding apparatus according to Embodiment 1;

FIG. 7 is a block diagram showing main components inside a second layer decoding section according to Embodiment 1;

FIG. 8 illustrates a case where each filter coefficient adopts 3 or 5 as the number of taps;

FIG. 9 is a block diagram showing another configuration of speech coding apparatus according to Embodiment 1;

FIG. 10 is a block diagram showing another configuration of speech decoding apparatus according to Embodiment 1;

FIG. 11 is a block diagram showing main components of a second layer coding section according to Embodiment 2 of the present invention;

FIG. 12 illustrates a method of generating an estimated spectrum of the higher band;

FIG. 13 is a block diagram showing main components of a second layer decoding section according to Embodiment 2;

FIG. 14 is a block diagram showing main components of a second layer coding section according to Embodiment 3 of the present invention;

FIG. 15 is a block diagram showing main components of a second layer decoding section according to Embodiment 3;

FIG. 16 is a block diagram showing main components of a second layer coding section according to Embodiment 4 of the present invention;

FIG. 17 is a block diagram showing main components inside a searching section according to Embodiment 4;

FIG. 18 is a block diagram showing main components of a second layer coding section according to Embodiment 5 of the present invention;

FIG. 19 illustrates processing according to Embodiment 5;

FIG. 20 illustrates processing according to Embodiment 5;

FIG. 21 is a flowchart showing the flow of processing in a second layer coding section according to Embodiment 5;

FIG. 22 is a block diagram showing main components of a second layer coding section according to Embodiment 5;

FIG. 23 illustrates a variation of Embodiment 5;

FIG. 24 illustrates a variation of Embodiment 5; and

FIG. 25 is a flowchart showing the flow of processing of the variation of Embodiment 5.

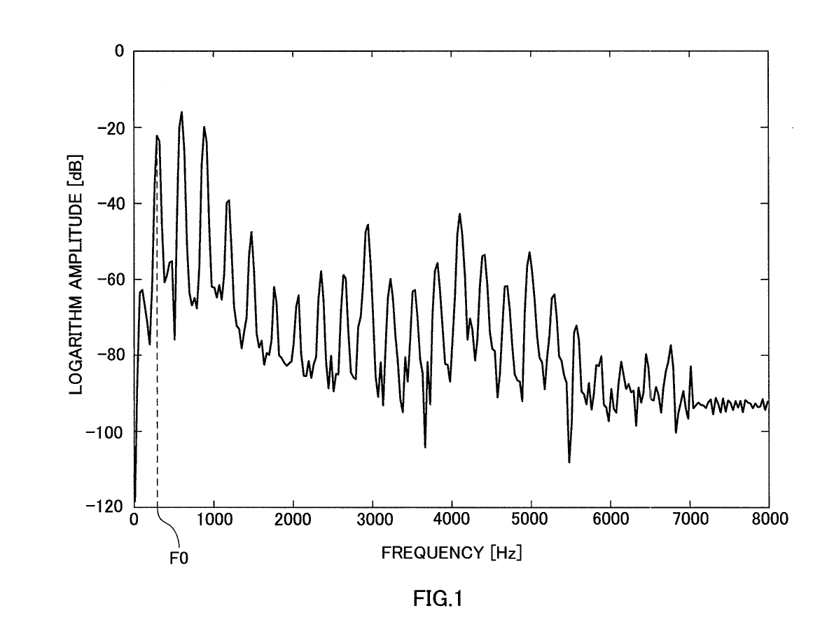

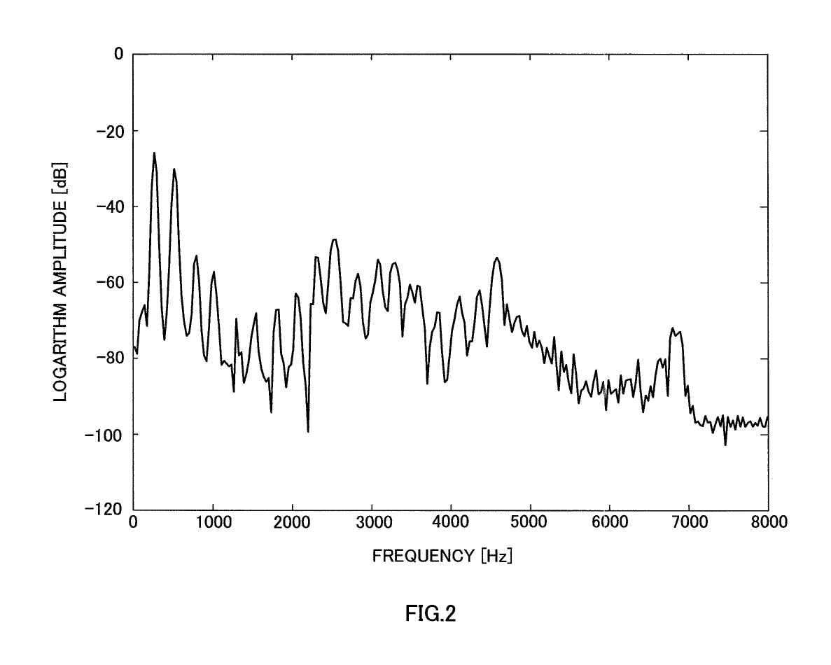

### BEST MODE FOR CARRYING OUT THE INVENTION

Embodiments of the present invention will be explained below in detail with reference to the accompanying drawings.

### Embodiment 1

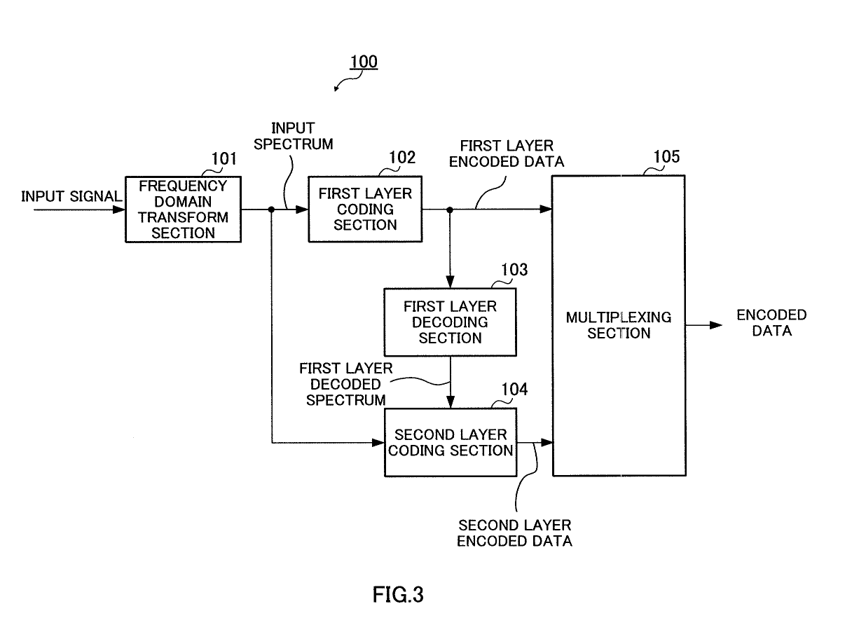

FIG. 3 is a block diagram showing main components of speech coding apparatus 100 according to Embodiment 1 of the present invention. Further, an example case will be explained here where frequency domain coding is performed in both the first layer and second layer.

Speech coding apparatus 100 is configured with frequency domain transform section 101, first layer coding section 102, first layer decoding section 103, second layer coding section 104 and multiplexing section 105, and performs frequency domain coding in the first layer and the second layer.

Speech coding apparatus 100 performs the following operations.

Frequency domain transform section 101 performs a frequency analysis of an input signal and obtains the spectrum of the input signal (i.e., input spectrum) in the form of transform coefficients. To be more specific, for example, frequency domain transform section 101 transforms the time domain signal into a frequency domain signal using the modified discrete cosine transform (“MDCT”). The input spectrum is outputted to first layer coding section 102 and second layer coding section 104.

First layer coding section 102 encodes the lower band 0≦k<FL of the input spectrum using, for example, the transform domain weighted interleave vector quantization (“TwinVQ”) and advanced audio coder (“AAC”), and outputs the first layer encoded data acquired by this coding to first layer decoding section 103 and multiplexing section 105.

First layer decoding section 103 generates the first layer decoded spectrum by decoding the first layer encoded data, and outputs the first layer decoded spectrum to second layer coding section 104. Here, first layer decoding section 103 outputs the first layer decoded spectrum that is not transformed into a time domain signal.

Second layer coding section 104 encodes the higher band FL≦k<FH of the input spectrum [0≦k<FH] outputted from frequency domain transform section 101 using the first layer decoded spectrum acquired in first layer decoding section 103, and outputs the second layer encoded data acquired by this coding to multiplexing section 105. To be more specific, second layer coding section 104 estimates the higher band of the input spectrum by pitch filtering processing using the first layer decoded spectrum as the filter state of the pitch filter. At this time, second layer coding section 104 estimates the higher band of the input spectrum not to collapse the harmonic structure of the spectrum. Further, second layer coding section 104 encodes filter information of the pitch filter. Second layer coding section 104 will be described later in detail.

Multiplexing section 105 multiplexes the first layer encoded data and the second layer encoded data, and outputs the resulting encoded data. This encoded data is superimposed over bit streams through, for example, the transmission processing section (not shown) of a radio transmitting apparatus having speech coding apparatus 100, and is transmitted to a radio receiving apparatus.

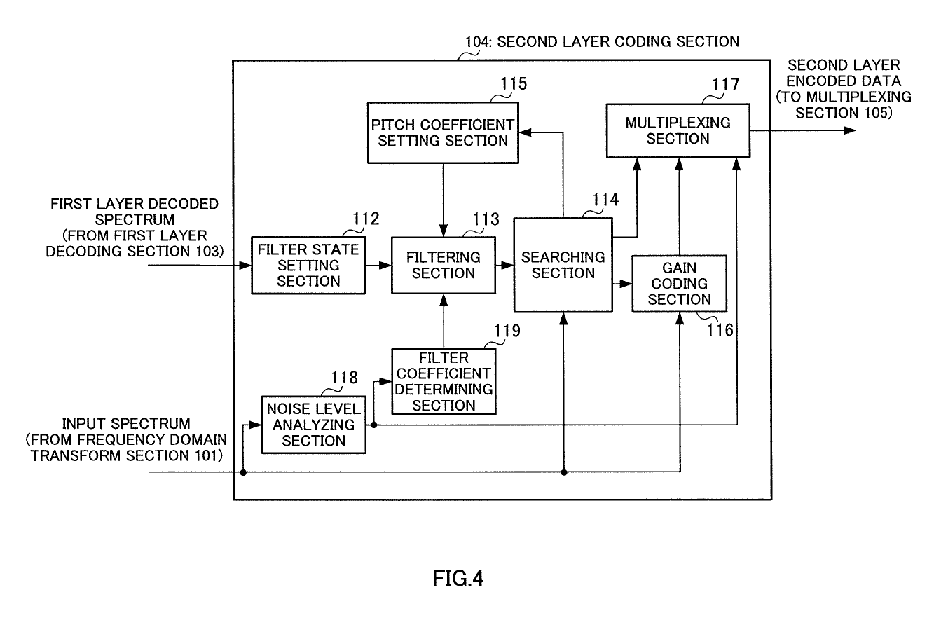

FIG. 4 is a block diagram showing main components inside second layer coding section 104 described above.

Second layer coding section 104 is configured with filter state setting section 112, filtering section 113, searching section 114, pitch coefficient setting section 115, gain coding section 116, multiplexing section 117, noise level analyzing section 118 and filter coefficient determining section 119, and these sections perform the following operations.

Filter state setting section 112 receives as input the first layer decoded spectrum S1(k) [0≦k<FL] from first layer decoding section 103. Filter status setting section 112 sets the filter state that is used in filtering section 113 using the first layer decoded spectrum.

Noise level analyzing section 118 analyzes the noise level in the higher band FL≦k<FH of the input spectrum S2(k) outputted from frequency domain transform section 101, and outputs noise level information indicating the analysis result, to filter coefficient determining section 119 and multiplexing section 117. For example, the spectral flatness measure (“SFM”) is used as noise level information. The SFM is expressed by the ratio of an arithmetic average of an amplitude spectrum to a geometric average of the amplitude spectrum (=geometric average/arithmetic average), and approaches 0.0 when the peak level of the spectrum becomes higher and approaches 1.0 when the noise level becomes higher. Further, it is equally possible to calculate a variance value after the energy of an amplitude spectrum is normalized and use the variance value as noise level information.

Filter coefficient determining section 119 stores a plurality of filter coefficient candidates, and selects one filter coefficient from the plurality of candidates according to the noise level information outputted from noise level analyzing section 118, and outputs the selected filter coefficient to filtering section 113. This is described later in detail.

Filtering section 113 has a multi-tap pitch filter (i.e., the number of taps is more than 1). Filtering section 113 calculates estimated spectrum S2′(k) of the input spectrum by filtering the first layer decoded spectrum, based on the filter state set in filter state setting section 112, the pitch coefficient outputted from pitch coefficient setting section 115 and the filter coefficient outputted from filter coefficient setting section 119. This is described later in detail.

Pitch coefficient setting section 115 changes the pitch coefficient T little by little, in the predetermined search range between Tₘᵢₙ and Tₘₐₓ under the control of searching section 114, and outputs the pitch coefficient T in order, to filtering section 113.

Searching section 114 calculates the similarity between the higher band FL≦k<FH of the input spectrum S2(k) outputted from frequency domain transform section 101 and the estimated spectrum S2′(k) outputted from filtering section 113. This calculation of the similarity is performed by, for example, correlation calculations. The processing between filtering section 113, searching section 114 and pitch coefficient setting section 115 forms a closed loop. Searching section 114 calculates the similarity matching each pitch coefficient by variously changing the pitch coefficient T outputted from pitch coefficient setting section 115, and outputs the pitch coefficient where the maximum similarity is calculated, that is, outputs an optimal pitch coefficient T′ (where T′ is in the range between Tₘᵢₙ and Tₘₐₓ) to multiplexing section 117. Further, searching section 114 outputs the estimation value S2′(k) of the input spectrum associated with this pitch coefficient T′ to gain coding section 116.

Gain coding section 116 calculates gain information of the input spectrum S2(k) based on the higher band FL≦k<FH of the input spectrum S2(k) outputted from frequency domain transform section 101. To be more specific, gain information is expressed by the spectrum power per subband and the frequency band FL≦k<FH is divided into J subbands. In this case, the spectrum power B(j) of the j-th subband is expressed by following equation 1.

$$\begin{matrix}( Equation 1 ) & \\ B ( j ) = {\sum }_{k = BL ( j )}^{BH ( j )} S 2 {( k )}^{2} & [ 1 ]\end{matrix}$$

In equation 1, the BL(j) is the lowest frequency in the j-th subband and the BH(j) is the highest frequency in the j-th subband. Subband information of the input spectrum calculated as above is referred to as gain information. Further, similarly, gain coding section 116 calculates subband information B′ (j) of the estimation value S2′ (k) of the input spectrum according to following equation 2 and calculates the variation V(j) per subband, according to following equation 3.

$$\begin{matrix}( Equation 2 ) & \\ {B}^{′} ( j ) = {\sum }_{k = BL ( j )}^{BH ( j )} S {2}^{′} {( k )}^{2} & [ 2 ] \\ ( Equation 3 ) & \\ V ( j ) = \sqrt{\frac{B ( j )}{{B}^{′} ( j )}} & [ 3 ]\end{matrix}$$

Further, gain coding section 116 encodes the variation V(j) and outputs an index associated with the encoded variation V_{q}(j), to multiplexing section 117.

Multiplexing section 117 multiplexes the optimal pitch coefficient T′ outputted from searching section 114, the index of the variation V(j) outputted from gain coding section 116 and the noise level information outputted from noise level analyzing section 118, and outputs the resulting second layer encoded data to multiplexing section 105. Here, it is equally possible to perform multiplexing in multiplexing section 105 without performing multiplexing in multiplexing section 117.

Next, processing in filter coefficient determining section 119 will be explained where the filter coefficient of filtering section 113 is determined based on the noise level in the higher band FL≦k<FH of the input spectrum S2(k).

In the filter coefficient candidates stored in filter coefficient determining section 119, the level of spectrum smoothing ability varies between filter coefficient candidates. The level of spectrum smoothing ability is determined by the degree of the difference between adjacent filter coefficient components. For example, when the difference between adjacent filter coefficient components of the filter coefficient candidate is large, the level of spectrum smoothing ability is low, and, when the difference between adjacent filter coefficient components of the filter coefficient candidate is small, the level of spectrum smoothing ability is high.

Further, filter coefficient determining section 119 arranges the filter coefficient candidates in order from the largest to smallest difference between adjacent filter coefficient components, that is, in order from the lowest to the highest level of spectrum smoothing ability. Filter coefficient determining section 119 decides the noise level by performing threshold decision for the noise level information outputted from noise level analyzing section 118, and determines which candidates in the plurality of filter coefficient candidates should be associated (used).

For example, when the number of taps is three, the filter coefficient candidates are (β₋₁, β₀, β₁). To be more specific, when the components of the filter coefficient candidates are (β₋₁, β₀, β₁)=(0.1, 0.8, 0.1), (0.2, 0.6, 0.2), (0.3, 0.4, 0.3), these filter coefficient candidates are stored in filter coefficient determining section 119 in order of (0.1, 0.8, 0.1), (0.2, 0.6, 0.2) and (0.3, 0.4, 0.3).

In this case, by comparing the noise level information outputted from noise level analyzing section 118 and a plurality of predetermined thresholds, filter coefficient determining section 119 decides the noise level low, medium or high. For example, the filter coefficient candidate (0.1, 0.8, 0.1) is selected when the noise level is low, the noise filter coefficient candidate (0.2, 0.6, 0.2) is selected when the noise level is medium, and the filter coefficient candidate (0.3, 0.4, 0.3) is selected when the noise level is high. This selected filter coefficient candidate is outputted to filtering section 113.

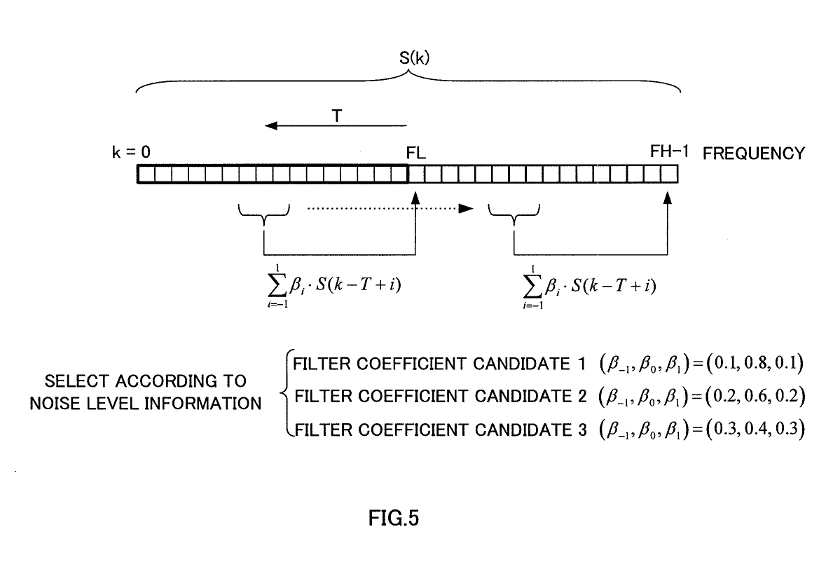

Next, the filtering processing in filtering section 113 will be explained in detail using FIG. 5.

Filtering section 113 generates the spectrum in the band FL≦k<FH, using the pitch coefficient T outputted from pitch coefficient setting section 115. Here, the spectrum of the entire frequency band (0≦k<FH) is referred to as “S(k)” for ease of explanation, and the result of following equation 4 is used as the filter function.

$$\begin{matrix}( Equation 4 ) & \\ P ( z ) = \frac{1}{1 - {\sum }_{i = - M}^{M} {β}_{i} {z}^{- T + i}} & [ 4 ]\end{matrix}$$

In this equation, T is the pitch coefficient given from pitch coefficient setting section 115, βᵢ is the filter coefficient given from filter coefficient determining section 119 and M is 1.

The band 0≦k<FL in S(k) stores the first layer decoded spectrum S1(k) as the internal state (filter state) of the filter.

The band FL≦k<FH in S(k) stores the estimation value S2′(k) of an input spectrum by filtering processing of the following steps. That is, the spectrum S(k−T) of a frequency that is lower than k by T, is basically assigned to this S2′(k). However, to improve the smooth characteristics of the spectrum, in fact, it is equally possible to assign to S2′(k), the sum of spectrums acquired by assigning all i's to spectrum βᵢ·S(k−T+i) nearby multiplying spectrum S(k−T+i) separated by i from spectrum S(k−T) by predetermined filter coefficient βᵢ. This processing is expressed by following equation 5.

$$\begin{matrix}( Equation 5 ) & \\ S {2}^{′} ( k ) = {\sum }_{i = - 1}^{1} {β}_{i} \cdot S ( k - T + i ) & [ 5 ]\end{matrix}$$

By performing the above calculation changing frequency k in the range of FL≦k<FH in order from the lowest frequency FL, the estimation values S2′(k) of the input spectrum in FL≦k<FH are calculated.

The above filtering processing is performed following zero-clearing the S(k) in the range of FL≦k<FH every time filter information setting section 115 provides the pitch coefficient T. That is, S(k) is calculated and outputted to searching section 114 every time the pitch coefficient T changes.

Thus, speech coding apparatus 100 according to the present embodiment controls the filter coefficients of the pitch filter used in filtering section 113, thereby smoothing the lower band spectrum and encoding the higher band spectrum using the smoothed lower band spectrum. In other words, according to the present embodiment, after the sharp peaks in the lower band spectrum, that is, the harmonic structure, are blunt by smoothing the lower band spectrum, an estimated spectrum (higher band spectrum) is generated based on the smoothed lower band spectrum. Therefore, the effect of smoothing the harmonic structure in the higher band spectrum, is provided. In this description, this processing is specifically referred to as “non-harmonic structuring.”

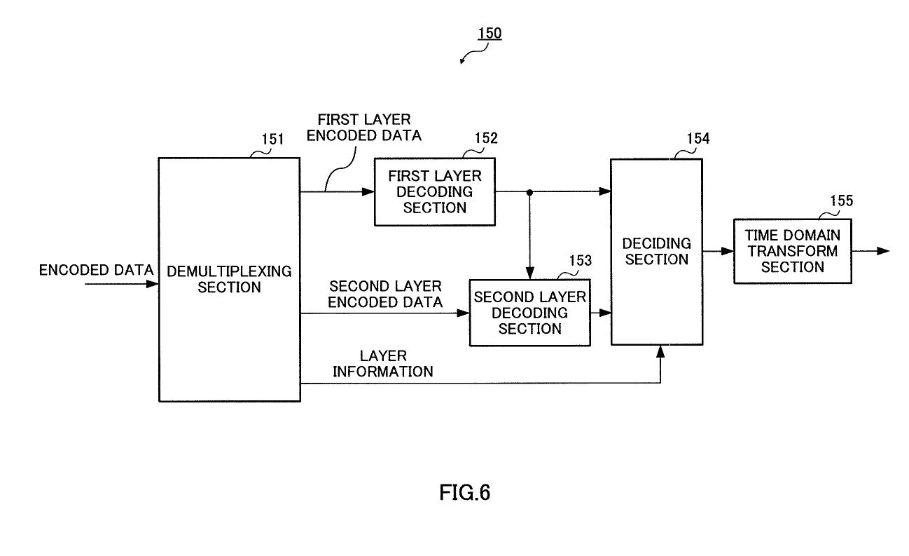

Next, speech decoding apparatus 150 of the present embodiment supporting speech coding apparatus 100 will be explained. FIG. 6 is a block diagram showing main components of speech decoding apparatus 150. This speech decoding apparatus 150 decodes encoded data generated in speech coding apparatus 100 shown in FIG. 3. The sections of speech decoding apparatus 150 perform the following operations.

Demultiplexing section 151 demultiplexes encoded data superimposed over bit streams transmitted from a radio transmitting apparatus into the first layer encoded data and the second layer encoded data, and outputs the first layer encoded data to first layer decoding section 152 and the second later encoded data to second layer decoding section 153. Further, demultiplexing section 151 demultiplexes from the bit streams, layer information showing to which layer the encoded data included in the above bit streams belongs, and outputs the layer information to deciding section 154.

First layer decoding section 152 generates the first layer decoded spectrum S1(k) by performing decoding processing on the first layer encoded data and outputs the result to second layer decoding section 153 and deciding section 154.

Second layer decoding section 153 generates the second layer decoded spectrum using the second layer encoded data and the first layer decoded spectrum S1(k), and outputs the result to deciding section 154. Here, second layer decoding section 153 will be described later in detail.

Deciding section 154 decides, based on the layer information outputted from demultiplexing section 151, whether or not the encoded data superimposed over the bit streams includes second layer encoded data. Here, although a radio transmitting apparatus having speech coding apparatus 100 transmits bit streams including both first layer encoded data and second layer encoded data, the second layer encoded data may be discarded in the middle of the communication path. Therefore, deciding section 154 decides, based on the layer information, whether or not the bit streams include second layer encoded data. Further, if the bit streams do not include second layer encoded data, second layer decoding section 153 do not generate the second layer decoded spectrum, and, consequently, deciding section 154 outputs the first layer decoded spectrum to time domain transform section 155. However, in this case, to match the order of the first layer decoded spectrum to the order of the decoded spectrum acquired by decoding bit streams including the second layer encoded data, deciding section 154 extends the order of the first layer decoded spectrum to FH, sets and outputs zero spectrum in the band between FL and FH. On the other hand, when the bit streams include both the first layer encoded data and the second layer encoded data, deciding section 154 outputs the second layer decoded spectrum to time domain transform section 155.

Time domain transform section 155 generates a decoded signal by transforming the decoded spectrum outputted from deciding section 154 into a time domain signal and outputs the decoded signal.

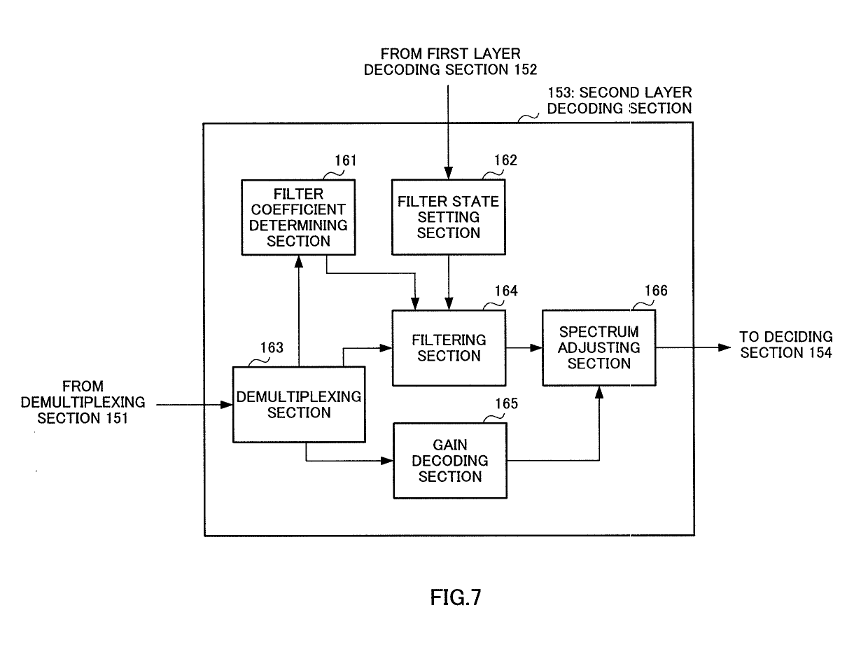

FIG. 7 is a block diagram showing main components inside second layer decoding section 153 described above.

Demultiplexing section 163 demultiplexes the second layer encoded data outputted from demultiplexing section 151 into information about filtering (i.e., optimal pitch coefficient T′), the information about gain (i.e., the index of variation V(j)) and noise level information, and outputs the information about filtering to filtering section 164, the information about the gain to gain decoding section 165 and the noise level information to filter coefficient determining section 161. Further, if these items of information have been demultiplexed in demultiplexing section 151, demultiplexing section 163 needs not be used.

Filter coefficient determining section 161 employs a configuration corresponding to filter coefficient determining section 119 inside second layer coding section 104 shown in FIG. 4. Filter coefficient determining section 161 stores a plurality of filter coefficient candidates (vector values), and selects one filter coefficient from the plurality of candidates according to the noise level information outputted from demultiplexing section 163, and outputs the selected filter coefficient to filtering section 164. The level of spectrum smoothing ability varies between the filter coefficient candidates stored in filter coefficient determining section 161. Further, these filter coefficient candidates are arranged in order from the lowest to the highest level of spectrum smoothing ability. Filter coefficient determining section 161 selects one filter coefficient candidate from the plurality of filter coefficient candidates with different levels of non-harmonic structuring according to the noise level information outputted from demultiplexing section 163, and outputs the selected filter coefficient to filtering section 164.

Filter state setting section 162 employs a configuration corresponding to the filter state setting section 112 in speech coding apparatus 100. Filter state setting section 162 sets the first layer decoded spectrum S1(k) from first layer decoding section 152 as the filter state that is used in filtering section 164. Here, the spectrum of the entire frequency band 0≦k<FH is referred to as “S(k)” for ease of explanation, and the first layer decoded spectrum S(k) is stored in the band 0≦k<FL in S(k) as the internal state (filter state) of the filter.

Filtering section 164 filters the first layer decoded spectrum S1(k) based on the filter state set in filter state setting section 162, the pitch coefficient T′ inputted from demultiplexing section 163 and the filter coefficient outputted from filter coefficient determining section 161, and calculates the estimated spectrum S2′(k) of the spectrum S2(k) according to above equation 5. Filtering section 164 also uses the filter function shown in above equation 4.

Gain decoding section 165 decodes the gain information outputted from demultiplexing section 163 and calculates the variation V_{q}(j) representing the quantization value of the variation V(j).

Spectrum adjusting section 166 adjusts the shape of the spectrum in the frequency band FL≦k≦FH of the estimated spectrum S2′(k) by multiplying the estimated spectrum S2′(k) outputted from filtering section 164 by the variation V_{q}(j) per subband outputted from gain decoding section 165, according to following equation 6, and generates the decoded spectrum S3(k).

(Equation 6)

S3(k)=S2′(k)·V_{q}(j)≦k≦BH(j),forall j) [6]

Here, the lower band 0≦k<FL of the decoded spectrum S3(k) is comprised of the first layer decoded spectrum S1(k) and the higher band FL≦k<FH of the decoded spectrum S3(k) is comprised of the estimated spectrum S2′(k) after the adjustment. This decoded spectrum S3(k) after the adjustment is outputted to deciding section 154 as the second layer decoded spectrum.

Thus, speech decoding apparatus 150 can decode encoded data generated in speech coding apparatus 100.

As described above, according to the present embodiment, by providing a multi-tap pitch filter and controlling the filter parameters such as filter coefficients in a method of efficiently encoding and decoding the higher band of a spectrum using the lower band of the spectrum, it is possible to encode the higher band of the spectrum after the lower band of the spectrum is subjected to non-harmonic structuring. That is, the higher band spectrum is predicted from the lower band spectrum using a pitch filter for attenuating the harmonic structure in the higher band of the spectrum. Here, in the present embodiment, “non-harmonic structuring” means smoothing a spectrum.

By this means, it is possible to prevent sound quality degradation in cases where the harmonic structure in the higher band spectrum generated by pitch filter processing is too significant and where there are not enough noise components in the higher band, thereby realizing sound quality improvement of a decoded signal.

Further, an example configuration has been described with the present embodiment where filter coefficients in which the difference between adjacent filter coefficient components is different, are used as the filter parameters. However, the filter parameters are not limited to this, and it is equally possible to employ a configuration using the number of taps of the pitch filter (i.e., the order of the filter), noise gain information, etc. For example, if the number of taps of the pitch filter is used as the filter parameter, the following processing is possible. Here, a configuration will be described later with Embodiment 2 where noise gain information is used.

In the above case, filter coefficient candidates stored in filter coefficient determining section 119 include respective numbers of taps (i.e., respective orders of the filter). That is, the number of taps of the filter coefficient is selected according to noise level information. By adopting such method, it is easier to design a pitch filter in which the level of spectrum smoothing ability becomes high when the number of taps of the pitch filter becomes greater. With this characteristic, it is possible to form a pitch filter attenuating the harmonic structure in the higher band of the spectrum significantly.

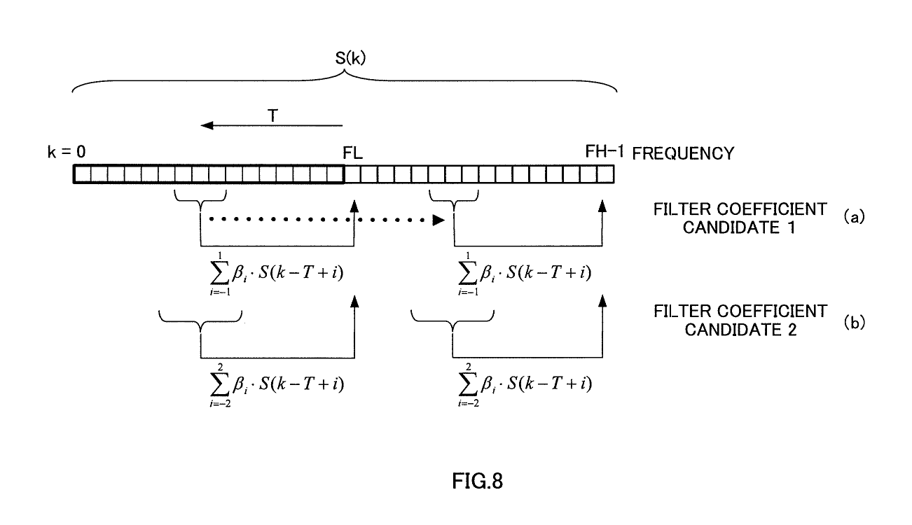

An example case will be explained below where the number of taps of each filter coefficient is three or five. FIG. 8(a) illustrates an outline of processing of generating the higher band spectrum in a case where the number of taps of a filter coefficient is three, and FIG. 8(b) illustrates an outline of processing of generating the higher band spectrum in a case where the number of taps of the filter coefficient is five. Assume that a filter coefficient where the number of taps is three, is (β₋₁, β₀, β₁)=(⅓, ⅓, ⅓) and a filter coefficient where the number of taps is five, is (β₋₂, β₋₁, β₀, β₁, β₂)=(⅕, ⅕, ⅕, ⅕, ⅕). The level of spectrum smoothing ability becomes higher when the number of taps of the filter coefficient becomes greater. Therefore, filter coefficient determining section 119 selects one of a plurality of candidates of tap numbers with different levels of non-harmonic structuring, according to the noise level information outputted from noise level analyzing section 118, and outputs the selected candidate to filtering section 113. To be more specific, when the noise level is low, a filter coefficient candidate with three taps is selected, and, when the noise level is high, a filter coefficient candidate with five taps is selected.

With this method, it is equally possible to prepare a plurality of filter coefficient candidates smoothing the spectrum at different levels. Further, although an example case has been described above where the number of taps of a pitch filter is an odd number, it is equally possible to use a pitch filter having an even number of taps.

Further, although an example configuration has been described with the present embodiment where a spectrum is smoothed as non-harmonic structuring, it is also possible to employ a configuration that performs processing of giving noise components to the spectrum as non-harmonic structuring.

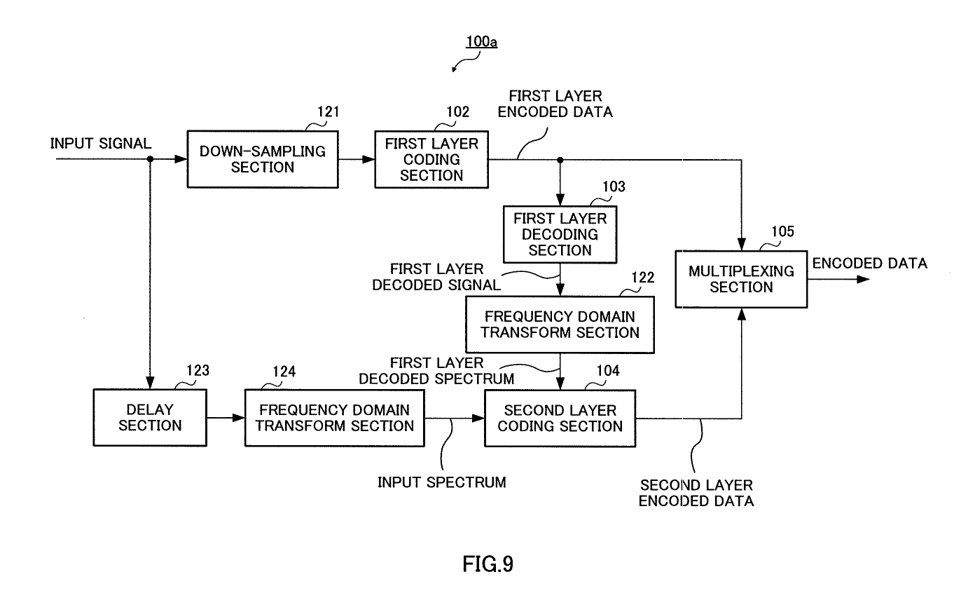

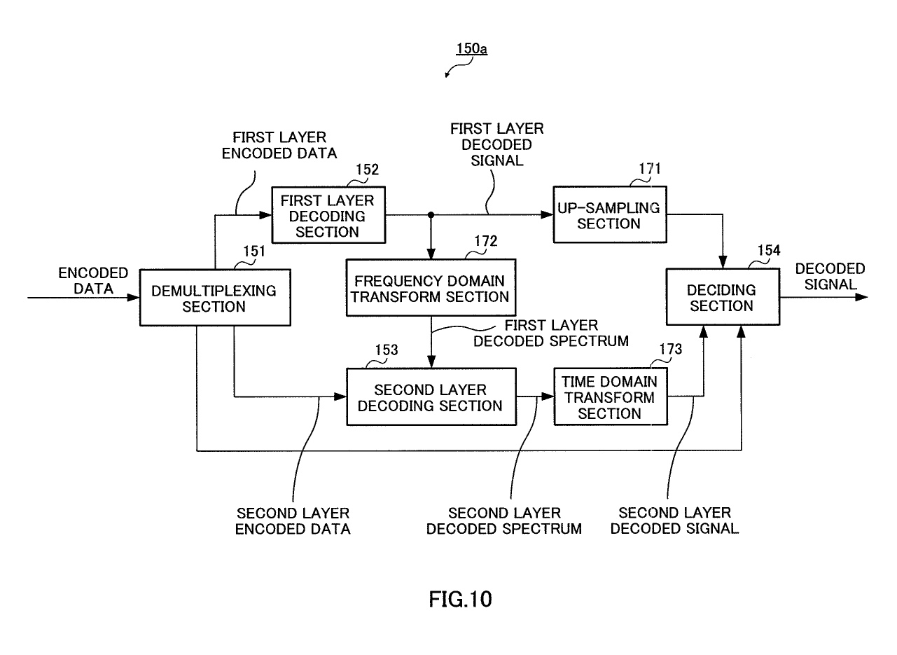

Further, in the present embodiment, the following configuration may be employed. FIG. 9 is a block diagram showing another configuration 100a of speech coding apparatus 100. Further, FIG. 10 is a block diagram showing main components of speech decoding apparatus 150a supporting speech coding apparatus 100. The same configurations as in speech coding apparatus 100 and speech decoding apparatus 150 will be assigned the same reference numerals and explanations will be naturally omitted.

In FIG. 9, down-sampling section 121 performs down-sampling of an input speech signal in the time domain and converts a sampling rate to a desired sampling rate. First layer coding section 102 encodes the time domain signal after the down-sampling using CELP coding, and generates first layer encoded data. First layer decoding section 103 decodes the first layer encoded data and generates a first layer decoded signal. Frequency domain transform section 122 performs a frequency analysis of the first layer decoded signal and generates a first layer decoded spectrum. Delay section 123 provides the input speech signal with a delay matching the delay caused between down-sampling section 121, first layer coding section 102, first layer decoding section 103 and frequency domain transform section 122. Frequency domain transform section 124 performs a frequency analysis of the input speech signal with the delay and generates an input spectrum. Second layer coding section 104 generates second layer encoded data using the first layer decoded spectrum and the input spectrum. Multiplexing section 105 multiplexes the first layer encoded data and the second layer encoded data, and outputs the resulting encoded data.

Further, in FIG. 10, first layer decoding section 152 decodes the first layer encoded data outputted from demultiplexing section 151 and acquires the first layer decoded signal. Up-sampling section 171 converts the sampling rate of the first layer decoded signal into the same sampling rate as the input signal. Frequency domain transform section 172 performs a frequency analysis of the first layer decoded signal and generates the first layer decode spectrum. Second layer decoding section 153 decodes the second layer encoded data outputted from demultiplexing section 151 using the first layer decoded spectrum and acquires the second layer decoded spectrum. Time domain transform section 173 transforms the second layer decoded spectrum into a time domain signal and acquires a second layer decoded signal. Deciding section 154 outputs one of the first layer decoded signal and the second layer decoded signal based on the layer information outputted from demultiplexing section 154.

Thus, in the above variation, first layer coding section 102 performs coding processing in the time domain. First layer coding section 102 uses CELP coding that can encode a speech signal with high quality at a low bit rate. Therefore, first layer coding section 102 uses the CELP coding, so that it is possible to reduce the overall bit rate of the scalable coding apparatus and realize sound quality improvement. Further, CELP coding can reduce an inherent delay (algorithm delay) compared to transform coding, so that it is possible to reduce the overall inherent delay of the scalable coding apparatus and realize speech coding processing and decoding processing suitable to mutual communication.

### Embodiment 2

In Embodiment 2 of the present invention, noise gain information is used as filter parameters. That is, according to the noise level of an input spectrum, one of a plurality of candidates of noise gain information with different levels of non-harmonic structuring is determined.

The basic configuration of the speech coding apparatus according to the present embodiment is the same as speech coding apparatus 100 (see FIG. 3) shown in Embodiment 1. Therefore, explanations will be omitted and second layer coding section 104b with a different configuration from second layer coding section 104 in Embodiment 1 will be explained.

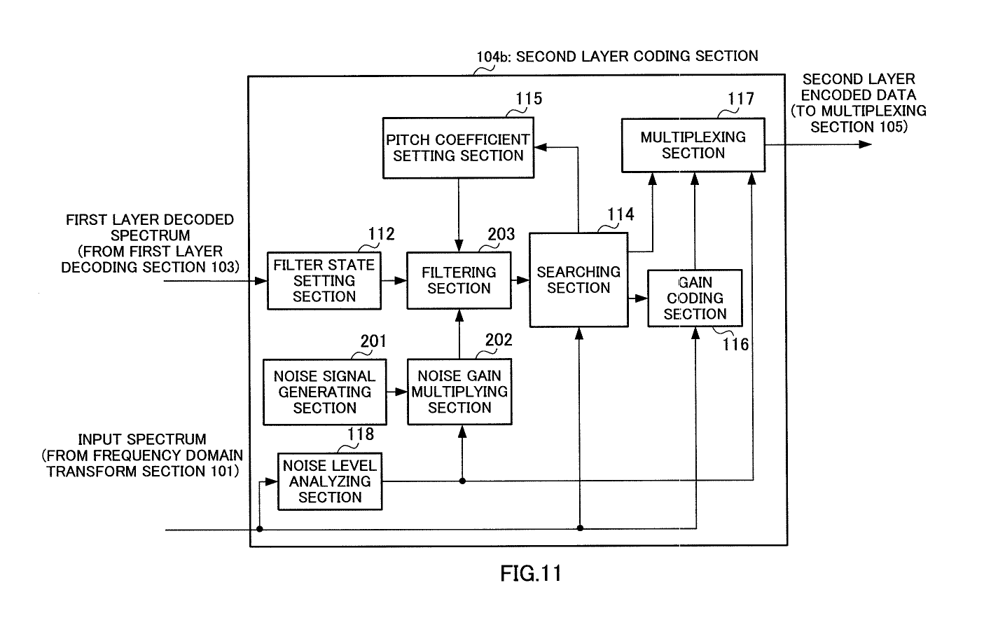

FIG. 11 is a block diagram showing main components of second layer coding section 104b. Further, the configuration of second layer coding section 104b is the same as second coding section 104 (see FIG. 4) shown in Embodiment 1, and the same components will be assigned the same reference numerals and explanations will be omitted.

Second layer coding section 104b is different from second layer coding section 104 in having noise signal generating section 201, noise gain multiplying section 202 and filtering section 203.

Noise signal generating section 201 generates noise signals and outputs them to noise gain multiplying section 202. For the noise signals, calculated random signals of which average value is zero or a signal sequence designed in advance is used.

Noise gain multiplying section 202 selects one of a plurality of candidates of noise gain information according to the noise level information given from noise level analyzing section 118, multiplies this selected noise gain information by the noise signal given from noise signal generating section 201, and outputs the resulting noise signal to filtering section 203. When this noise gain information becomes greater, the harmonic structure in the higher band of a spectrum can be attenuated more. The noise gain information candidates stored in noise gain multiplying section 202 are designed in advance, and are generally common between the speech coding apparatus and the speech decoding apparatus. For example, assume that three candidates G1, G2, G3 are stored as noise gain information candidates in the relationship 0<G1<G2<G3. Here, noise gain multiplying section 202 selects the candidate G1 when the noise information from noise level analyzing section 118 shows that the noise level is low, selects the candidate G2 when the noise level is medium, and selects the candidate G3 when the noise level is high.

Filtering section 203 generates the spectrum in the band FL≦k<FH, using the pitch coefficient T outputted from pitch coefficient setting section 115. Here, the spectrum of the entire frequency band (0≦k<FH) is referred to as “S(k)” for ease of explanation, and the result of following equation 7 is used as the filter function.

$$\begin{matrix}( Equation 7 ) & \\ P ( z ) = \frac{{G}_{n}}{1 - {\sum }_{i = - M}^{M} {β}_{i} \cdot {z}^{- T + i}} & [ 7 ]\end{matrix}$$

In this equation, Gn is the noise gain information indicating one of G1, G2 and G3. Further, T is the pitch coefficient given from pitch coefficient setting section 115, and M is 1.

The band of 0≦k<FL in S(k) stores the first layer decoded spectrum S1(k) as the filter state of the filter.

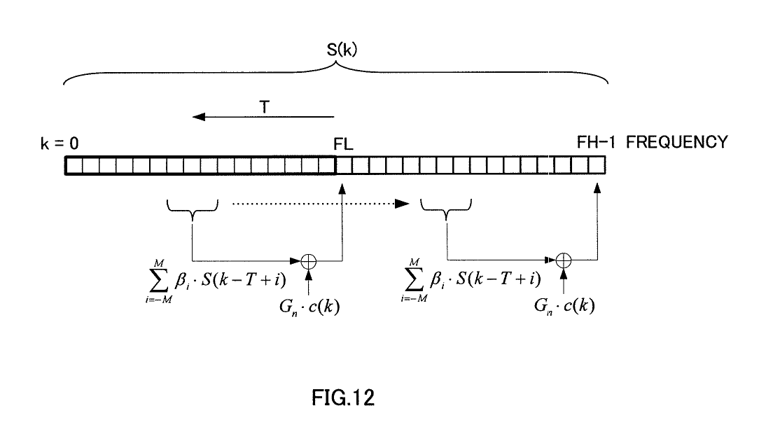

The band of FL≦k<FH in S(k) stores the estimation value S2′(k) of the input spectrum by filtering processing of the following steps (see FIG. 12). As shown in the figure, the spectrum acquired by adding the spectrum S(k−T) that is lower than k by T and noise signal Gₙ·c(k) multiplied by noise gain information Gₙ, is basically assigned to S2′(k). However, to improve the smooth characteristics of the spectrum, the sum of spectrums acquired by assigning all i's to spectrum βᵢ·S(k−T+i) multiplying nearby spectrum S(k−T+i) separated by i from spectrum S(k−T) by predetermined filter coefficient βᵢ, is actually used, instead of S(k−T). That is, the spectrum expressed by following equation 8 is assigned to S2′(k).

$$\begin{matrix}( Equation 8 ) & \\ S {2}^{′} ( k ) = {G}_{n} \cdot c ( k ) + {\sum }_{i = - 1}^{1} {β}_{i} \cdot S ( k - T + i ) & [ 8 ]\end{matrix}$$

By performing the above calculation by changing frequency k in the range of FL≦k<FH in order from the lowest frequency FL, estimation values S2′(k) of the input spectrum in FL≦k<FH are calculated.

Thus, the speech coding apparatus according to the present embodiment adds noise components based on noise level information acquired in noise level analyzing section 118, to the higher band of a spectrum. Therefore, when the noise level in the higher band of an input spectrum becomes higher, more noise components are assigned to the higher band of the estimated spectrum. In other words, according to the present embodiment, by adding noise components in the process of estimating the higher band spectrum from the lower band spectrum, sharp peaks in the estimated spectrum (i.e., higher band spectrum), that is, the harmonic structure is smoothed. In the present description, this processing is also referred to as “non-harmonic structuring.”

Next, the speech decoding apparatus according to the present embodiment will be explained. The basic configuration of the speech decoding apparatus according to the present embodiment is the same as speech decoding apparatus 150 (see FIG. 7) shown in Embodiment 1. Therefore, explanations will be omitted and second layer coding section 153b with a different configuration from second layer coding section 153 in Embodiment 1 will be explained.

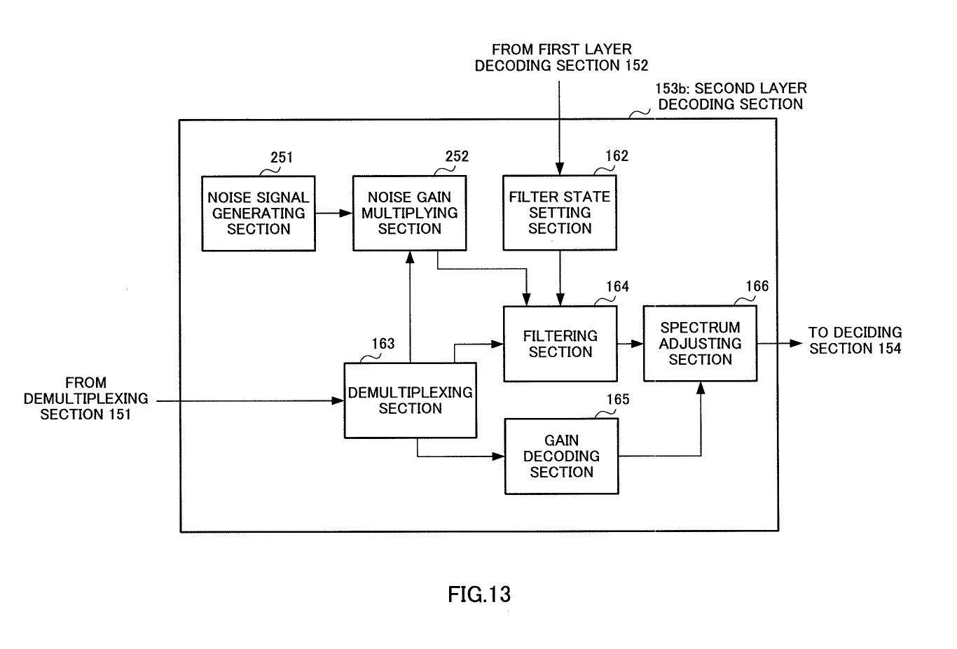

FIG. 13 is a block diagram showing main components of second layer decoding section 153b. Further, the configuration of second layer decoding section 153b is similar to speech decoding apparatus 153 (see FIG. 7) shown in Embodiment 1. Therefore, the same components will be assigned the same reference numerals and detailed explanations will be omitted.

Second layer decoding section 153b is different from second layer decoding section 153 in having noise signal generating section 251 and noise gain multiplying section 252.

Noise signal generating section 251 generates noise signals and outputs them to noise gain multiplying section 252. As the noise signals, calculated random signals of which average value is zero or a signal sequence designed in advance is used.

Noise gain multiplying section 252 selects one of a plurality of stored candidates of noise gain information according to the noise level information outputted from demultiplexing section 163, multiplies the selected noise gain information by the noise signal given from noise signal generating section 251, and outputs the resulting noise signal to filtering section 164. The following operations are as shown in Embodiment 1.

Thus, the speech decoding apparatus according to the present embodiment can decode encoded data generated in the speech coding apparatus according to the present embodiment.

As described above, according to the present embodiment, a harmonic structure is smoothed by assigning noise components to the higher band of the estimated spectrum. Therefore, as in Embodiment 1, according to the present embodiment, it is equally possible to avoid sound quality degradation due to a lack of noise of the higher band and realize sound quality improvement.

Further, although an example configuration has been described with the present embodiment where the noise level of an input spectrum is used, it is equally possible to employ a configuration in which the noise level of the first layer decoded spectrum are used instead of an input spectrum.

Further, it is equally possible to employ a configuration in which noise gain information by which a noise signal is multiplied changes according to the average amplitude value of estimation values S2′(k) of the input spectrum. That is, noise gain information is calculated according to the average amplitude value of estimation values S2′(k) of an input spectrum.

To be more specific about the above processing, first, Gn is set 0 and estimation values S2′(K) of the input spectrum are calculated, and the average energy ES2′ of the estimated values S2′(k) of this input spectrum is calculated. Similarly, the average energy EC of the noise signals c(k) is calculated, and noise gain information is calculated according to following equation 9.

$$\begin{matrix}( Equation 9 ) & \\ Gn = An \cdot \sqrt{\frac{ES {2}^{′}}{EC}} & [ 9 ]\end{matrix}$$

Here, An is the correlation value of noise gain information. For example, three candidates A1, A2, A3 are stored as correlation value candidates of noise gain information in the relationship 0<A1<A2<A3. Further, noise gain multiplying section 252 selects the candidate A1 when the noise information from noise level analyzing section 118 shows that the noise level is low, selects the candidate A2 when the noise level is medium, and selects the candidate A3 when the noise level is high.

By calculating noise gain information as described above, it is possible to adaptively calculate noise gain information by which the noise signal c(k) is multiplied according to the average amplitude value of the estimated values S2′(k) of the input spectrum, thereby improving sound quality.

### Embodiment 3

The basic configuration of the speech coding apparatus according to Embodiment 3 of the present invention is the same as speech coding apparatus 100 shown in Embodiment 1. Therefore, explanations will be omitted and second coding section 104c that is different from second layer coding section 104 of Embodiment 1 will be explained.

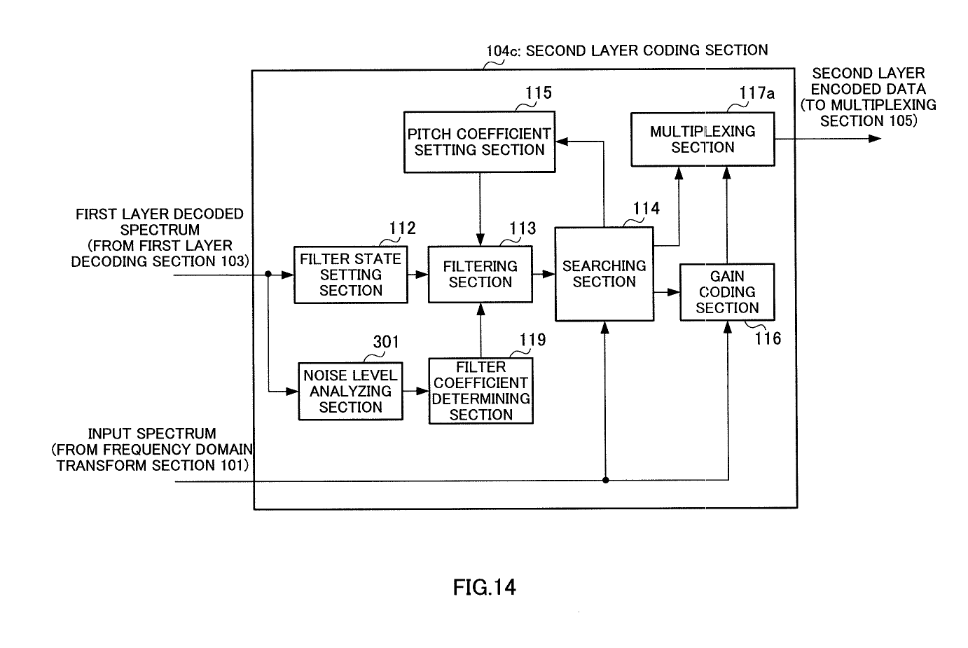

FIG. 14 is a block diagram showing main components of second layer coding section 104c. Further, the configuration of second layer coding section 104c is similar to second layer coding section 104 shown in Embodiment 1. Therefore, the same components will be assigned the same reference numerals and explanations will be omitted.

Second layer coding section 104c is different from second layer coding section 104 in that an input signal assigned to noise level analyzing section 301 is the first layer decoded spectrum.

Noise level analyzing section 301 analyzes the noise level of the first layer decoded spectrum outputted from first layer decoding section 103 in the same way as in noise level analyzing section 118 shown in Embodiment 1, and outputs noise level information showing the analysis result to filter coefficient determining section 119. That is, according to the present embodiment, the filter parameters of a pitch filter are determined according to the noise level of the first layer decoded spectrum acquired by decoding the first layer.

Further, noise level analyzing section 301 does not output noise level information to multiplexing section 117. That is, according to the present invention, as shown below, noise level information can be generated in the speech decoding apparatus, so that noise level information is not transmitted from the speech coding apparatus to the speech decoding apparatus according to the present embodiment.

The basic configuration of the speech decoding apparatus according to the present embodiment is the same as speech decoding apparatus 150 shown in Embodiment 1. Therefore, explanations will be omitted, and second layer decoding section 153c which is different from second layer decoding section 153 of Embodiment 1 will be explained.

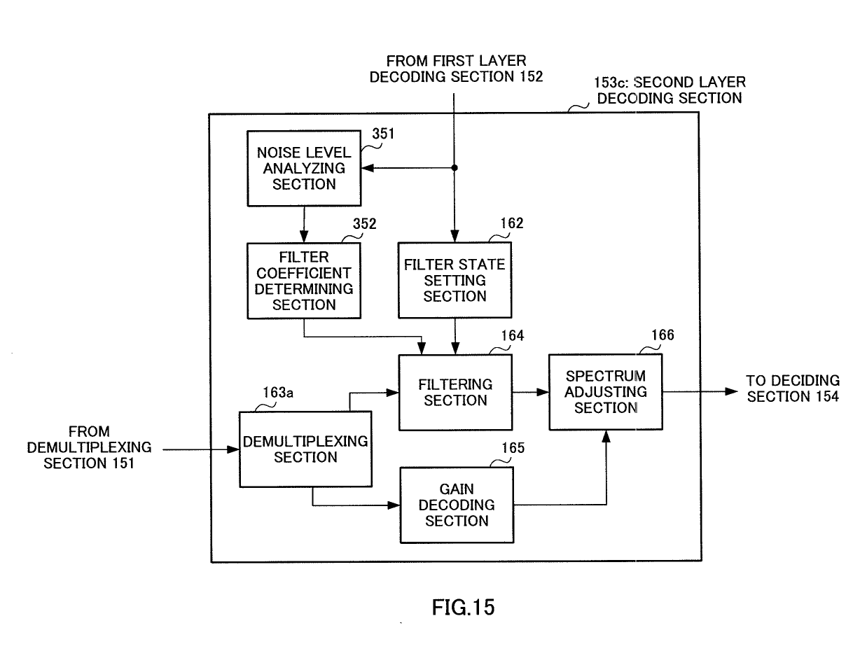

FIG. 15 is a block diagram showing main components of second layer decoding section 153b. Therefore, the same components will be assigned the same reference numerals and explanations will be omitted.

Second layer decoding section 153c is different from second layer decoding section 153 in that an input signal assigned to noise level analyzing section 351 is the first layer decoded spectrum.

Noise level analyzing section 351 analyzes the noise level of the first layer decoded spectrum outputted from first layer decoding section 152 and outputs noise level information showing the analysis result, to filter coefficient determining section 352. Therefore, additional information is not inputted from demultiplexing section 163a to filter coefficient determining section 352.

Filter coefficient determining section 352 stores a plurality of candidates of filter coefficients (vector values), and selects one filter coefficient from the plurality of candidates according to the noise level information outputted from noise level analyzing section 351, and outputs the result to filtering section 164.

Thus, according to the present embodiment, the filter parameter of the pitch filter is determined according to the noise level of the first layer decoded spectrum acquired by decoding the first layer. By this means, the speech coding apparatus needs not transmit additional information to the speech decoding apparatus, thereby reducing the bit rates.

### Embodiment 4

In Embodiment 4 of the present invention, the filter parameter is selected from filter parameter candidates to generate an estimated spectrum having great similarity to the higher band of an input spectrum. That is, in the present embodiment, estimated spectrums are actually generated with respect to all filter coefficient candidates, and the filter coefficient candidates are determined such that the similarity between the estimated spectrums and the input spectrum is maximized.

The basic configuration of the speech coding apparatus according to the present embodiment is the same as speech coding apparatus 100 shown in Embodiment 1. Therefore, explanations will be omitted and second layer coding section 104d which is different from second layer coding section 104 will be explained.

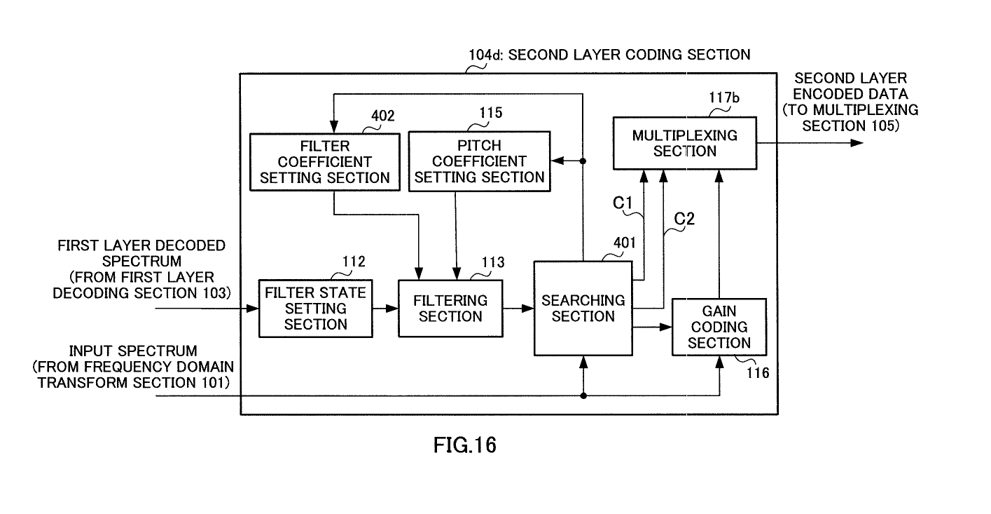

FIG. 16 is a block diagram showing main components of second layer coding section 104b. The same components as second layer coding section 104 shown in Embodiment 1 will be assigned the same reference numerals and explanations will be omitted.

Second layer coding section 104d is different from second layer coding section 104 in that there is a new closed-loop between filter coefficient setting section 402, filtering section 113 and searching section 401.

Under the control of searching section 401, filter coefficient setting section 402 calculates the estimation values S2′(k) of the higher band of the input spectrum for filter coefficient candidates βᵢ^{(j)}([0≦j<J] where j is the candidate number of the filter coefficient and J is the number of filter coefficient candidates).

$$\begin{matrix}( Equation 10 ) & \\ S {2}^{′} ( k ) = {\sum }_{i = - M}^{M} {β}_{i}^{( j )} \cdot S ( k - T + i ) & [ 10 ]\end{matrix}$$

Further, filter coefficient setting section 402 calculates the similarity between these estimation value S2′(k) and the higher band of the input spectrum S2(k), and determines the filter coefficient candidate βᵢ^{(j)} maximizing the similarity. Here, it is equally possible to calculate the error instead of the similarity and determine the filter coefficient candidate minimizing the error.

FIG. 17 is a block diagram showing main components inside searching section 401.

Shape error calculating section 411 calculates the shape error Es between the estimated spectrum S2′(k) outputted from filtering section 113 and the input spectrum S2(k) outputted from frequency domain transform section 101, and outputs the calculated shape error Es to weighted average error calculating section 413. The shape error Es can be calculated from following equation 11.

$$\begin{matrix}( Equation 11 ) & \\ Es = {\sum }_{k = FL}^{FH - 1} S 2 {( k )}^{2} - \frac{{( {\sum }_{k = FL}^{FH - 1} S 2 ( k ) \cdot S {2}^{′} ( k ) )}^{2}}{{\sum }_{k = FL}^{FH - 1} S {2}^{′} {( k )}^{2}} & [ 11 ]\end{matrix}$$

Noise level error calculating section 412 calculates the noise level error En between the noise level of the estimated spectrum S2′(k) outputted from filtering section 113 and the noise level of the input spectrum S2(k) outputted from frequency domain transform section 101. The spectral flatness measure of the input spectrum S2(k) (“SFM_i”) and the spectral flatness measure of the estimated spectrum S2′(k) (“SFM_p”) are calculated, and the noise level error En is calculated using the SFM_i and SFM_p according to following equation 12.

(Equation 12)

En=|SFM_{—}i−SFM_{—}p|² [12]

Weighted average error calculating section 413 calculates the weighted average error E between the shape error Es calculated in shape error calculating section 411 and the noise level error En calculated in noise level error calculating section 412 using the shape error Es and the noise level error En, and outputs the weighted average error E to deciding section 414. For example, the weighted average error E is calculated using weights γₛ and γₙ as shown in following equation 13.

(Equation 13)

E=γₛ·Eₛ+γₙ·Eₙ [13]

Deciding section 414 variously changes the pitch coefficient and the filter coefficient by outputting a control signal to pitch coefficient setting section 115 and filter coefficient setting section 402, finally calculates the pitch coefficient candidate and the filter coefficient candidate associated with the estimated spectrum such that the weighted average error E is minimum (i.e., the similarity is maximum), outputs information showing the calculated pitch coefficient and information showing the calculated filter coefficient (C1 and C2) to multiplexing section 117, and outputs the finally acquired estimated spectrum to gain coding section 116.

Further, the configuration of the speech decoding apparatus according to the present embodiment is the same as in speech decoding apparatus 150 shown in Embodiment 1. Therefore, explanations will be omitted.

As described above, according to the present embodiment, the filter parameter of the pitch filter in the maximum similarity between the higher band of the input spectrum and the estimated spectrum, is selected, thereby realizing sound quality improvement. Further, the equation to calculate the similarity is formed to take into account the noise level of the higher band of the input spectrum.

Further, it is equally possible to change the amounts of weights γₛ and γₙ according to the noise level of the input spectrum or the first layer decoded spectrum. In this case, when the noise level is high, γₙ is set greater than γₛ, and, when the noise level is low, γₙ is set less than γₛ. By this means, it is possible to set an appropriate weight for the input spectrum or the first layer decoded spectrum, thereby improving sound quality more.

Further, in the present embodiment, it is possible to employ a configuration in which the shape error Es and the noise level error En are calculated on a per subband basis, to calculate the weighted average E. In this case, weights associated with the noise level can be set every subband in the higher band spectrum, thereby improving the sound quality more.

Further, in the present embodiment, it is possible to employ a configuration using only one of the shape error and the noise level error. In the case of using only the shape error to calculate the similarity, in FIG. 17, noise level error calculating section 412 and weighted average error calculating section 413 are not necessary, and the output of shape error calculating section 411 is directly outputted to deciding section 414. On the other hand, in the case of using only the noise level error to calculate the similarity, shape error calculating section 411 and weighted average error calculating section 413 are not necessary, and the output of noise level calculating section 412 is directly outputted to deciding section 414.

Further, it is equally possible to determine the filter coefficient and search for the pitch coefficient at the same time. In this case, with respect to all combinations of filter coefficient candidates and pitch coefficient candidates, estimated spectrums S2′(k) are calculated according to equation 10 to determine the filter coefficient candidate βᵢ^{(j)} and the optimal pitch coefficient T′ (in the range between Tₘᵢₙ and Tₘₐₓ) maximizing the similarity between the estimated spectrums S2′(k) and the higher band of the input spectrum S2(k), at the same time.

Further, it is equally possible to adopt a method of determining the filter coefficient first and then determining the pitch coefficient or adopt a method of determining the pitch coefficient first and then determining the filter coefficient. In this case, compared to a case where all combinations are searched, it is possible to reduce the amount of calculations.

### Embodiment 5

In Embodiment 5 of the present invention, upon selecting a filter parameter, a filter parameter with the higher level of non-harmonic structuring is selected at higher frequencies in the higher band of the spectrum. Here, an example configuration will be explained where the filter coefficient is used as the filter parameter.

The basic configuration of the speech coding apparatus according to the present embodiment is the same as speech coding apparatus 100 shown in Embodiment 1. Therefore, explanations will be omitted, and second layer coding section 104e which is different from second layer coding section 104 of Embodiment 1 will be explained below.

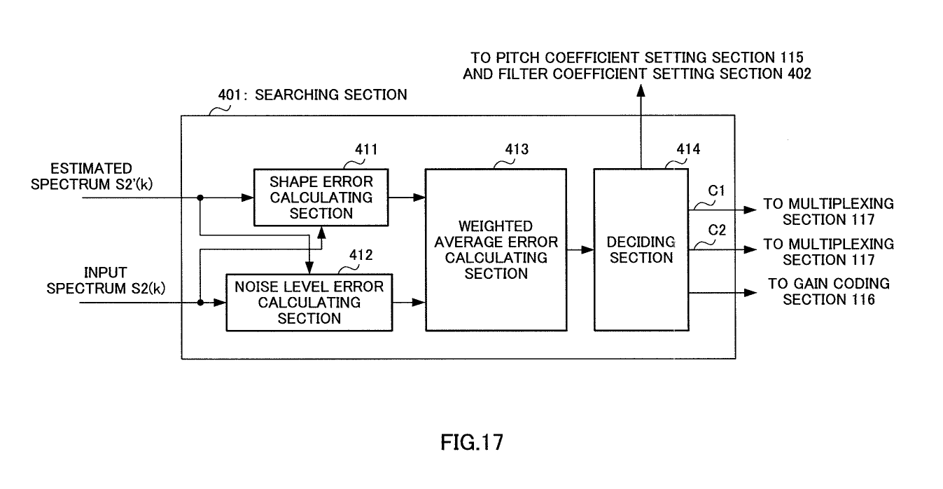

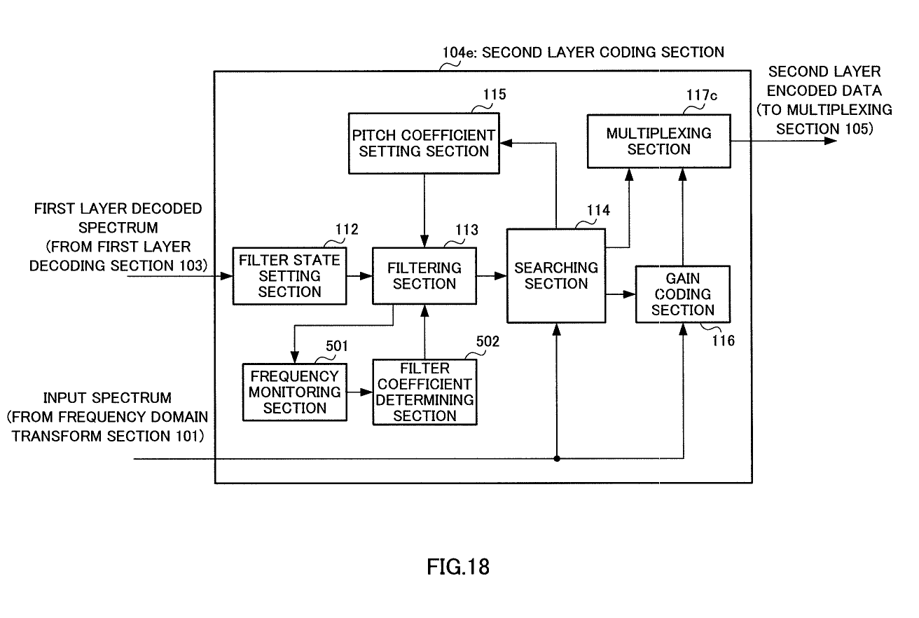

FIG. 18 is a block diagram showing main components of second layer coding section 104e. The same components as second layer coding section 104 shown in Embodiment 1 will be assigned the same reference numerals and explanations will be omitted.

Second layer coding section 104e is different from second layer coding section 104 in having frequency monitoring section 501 and filter coefficient determining section 502.

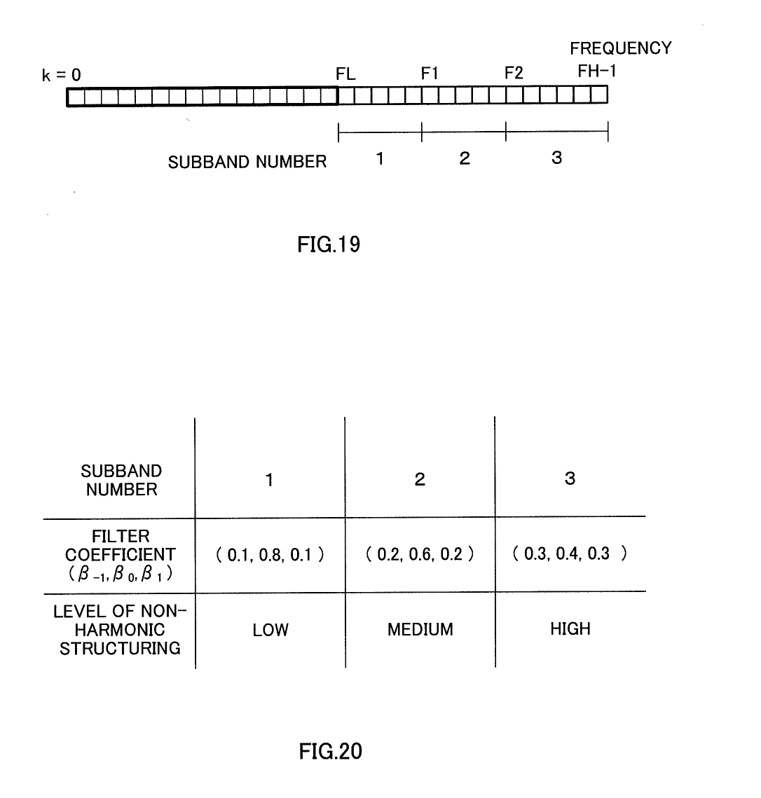

In the present embodiment, the higher band FL≦k<FH [FL≦k≦FH−1] of a spectrum is divided into a plurality of subbands in advance (see FIG. 19). Here, the number of divided subbands is three, as an example. Further, the filter coefficient is set in advance per subband (see FIG. 20). This filter coefficient with the higher level of non-harmonic structuring is set in the higher-frequency subband.

In the filtering processing in filtering section 113, frequency monitoring section 501 monitors the frequency at which the estimated spectrum is currently generated, and outputs the frequency information to filter coefficient determining section 502.

Filter coefficient determining section 502 determines based on the frequency information outputted from frequency monitoring section 501, to which subbands in the higher band spectrum the frequency currently processed in filtering section 113 belongs, determines the filter coefficient for use with reference to the table shown in FIG. 20, and outputs the determined filter coefficient to filtering section 113.

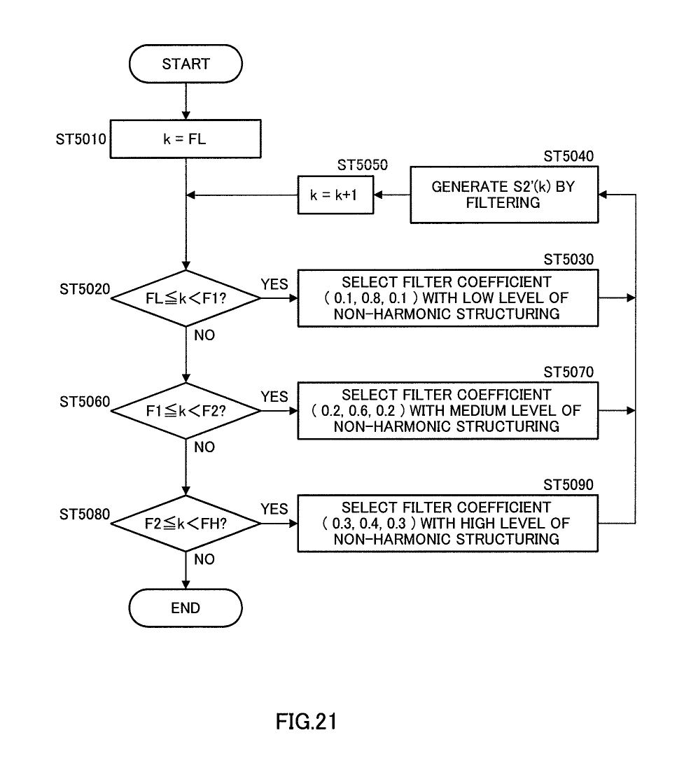

Next, the flow of processing in second layer coding section 104e will be explained using the flowchart shown in FIG. 21.

First, the value of the frequency k is set FL (ST5010). Next, whether or not the frequency k is included in the first subband, that is, whether or not the relationship FL≦k<F1 holds, is decided (ST5020). In the event of “YES” in ST5020, second layer coding section 104e selects the filter coefficient of the “low” level of non-harmonic structuring (ST5030), generates the estimation value S2′(k) of the input spectrum by performing filtering (ST5040), and increments the variable k by one (ST5050).

In the event of “NO” in ST5020, whether or not the frequency k is included in the second subband, that is, whether or not the relationship F1≦k<F2 holds, is decided (ST5060). In the event of “YES” in ST5060, second layer coding section 104e selects the filter coefficient of the “medium” level of non-harmonic structuring (ST5070), generates the estimation value S2′(k) of the input spectrum by performing filtering (ST5040), and increments the variable k by one (ST5050).

In the event of “NO” in ST5060, whether or not the frequency k is included in the third subband, that is, whether or not the relationship F2≦k<FH holds, is decided (ST5080). In the event of “YES” in ST5080, second layer coding section 104e selects the filter coefficient of the “high” level of non-harmonic structuring (ST5090), generates the estimation value S2′(k) of the input spectrum by performing filtering (ST5040), and increments the variable k by one (ST5050). In the event of “NO” in ST5080, since all estimation values S2′(k) in predetermined frequencies are generated, the processing is finished.

The basic configuration of the speech decoding apparatus according to the present embodiment is the same as speech decoding apparatus 150 shown in Embodiment 1. Therefore, explanations will be omitted and second layer decoding section 153e employing the different configuration from second layer decoding section 153 will be explained.

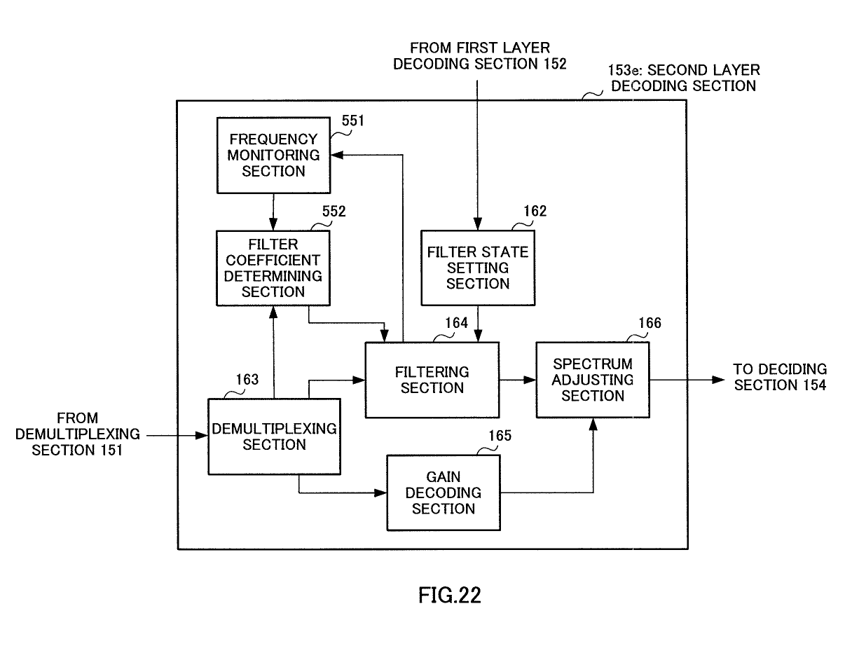

FIG. 22 is a block diagram showing main components of second layer decoding section 153e. The same components as second layer decoding section 153 shown in Embodiment 1 will be assigned the same reference numerals and explanations will be omitted.

Second layer decoding section 153e is different from second layer decoding section 153 in having frequency monitoring section 551 and filter coefficient determining section 552.

In the filtering processing in filtering section 164, frequency monitoring section 551 monitors the frequency at which the estimated spectrum is currently generated, and outputs the frequency information to filter coefficient determining section 552.

Filter coefficient determining section 552 decides to which subbands in the higher band spectrum the frequency currently processed in filtering section 164 belongs based on the frequency information outputted from frequency monitoring section 551, and determines the filter coefficient by referring to the same table as in FIG. 20, and outputs the determined filter coefficient to filtering section 164.

The flow of processing in second layer decoding section 153e is the same as in FIG. 21.

Thus, according to the present embodiment, upon selecting filter parameters, filter parameters with the higher level of non-harmonic structuring are selected at higher frequencies in the higher band of the spectrum. By this means, the level of non-harmonic structuring becomes greater at higher frequencies in the higher band, which is suitable for a feature of the higher noise level at higher frequencies in the higher band of a speech signal, so that it is possible to realize sound quality improvement. Further, the speech coding apparatus according to the present embodiment needs not transmit additional information to the speech decoding apparatus.

Further, although an example configuration has been described with the present embodiment where non-harmonic structuring is performed for the entire band of the higher band spectrum, it is equally possible to employ a configuration in which there are subbands not perform non-harmonic structuring, that is, a configuration in which non-harmonic structuring is performed for part of the higher band spectrum.

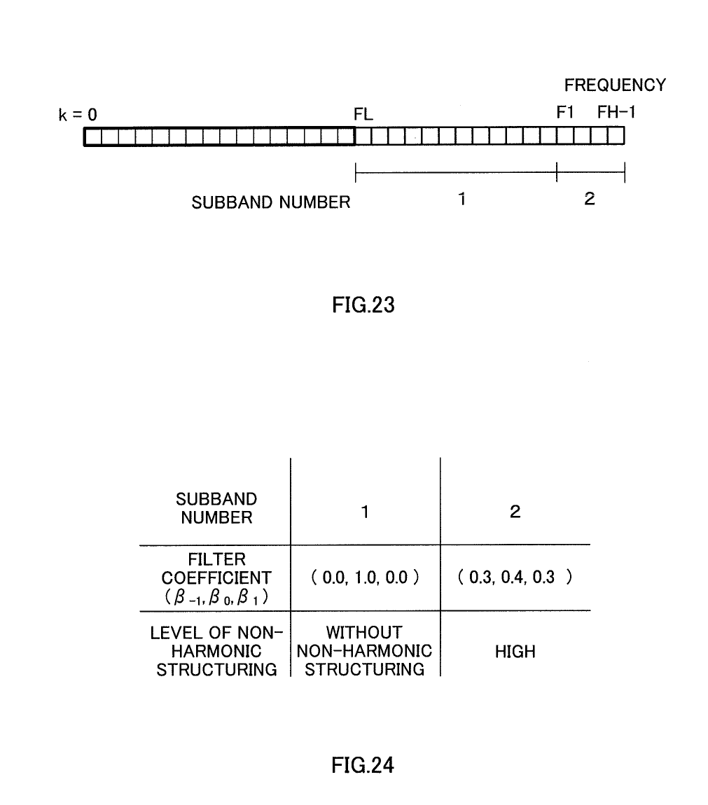

FIGS. 23 and 24 illustrate a detailed example of filtering processing where the number of subbands is two and non-harmonic structuring is not performed to calculate estimation values S2′(k) of an input spectrum included in the first subband.

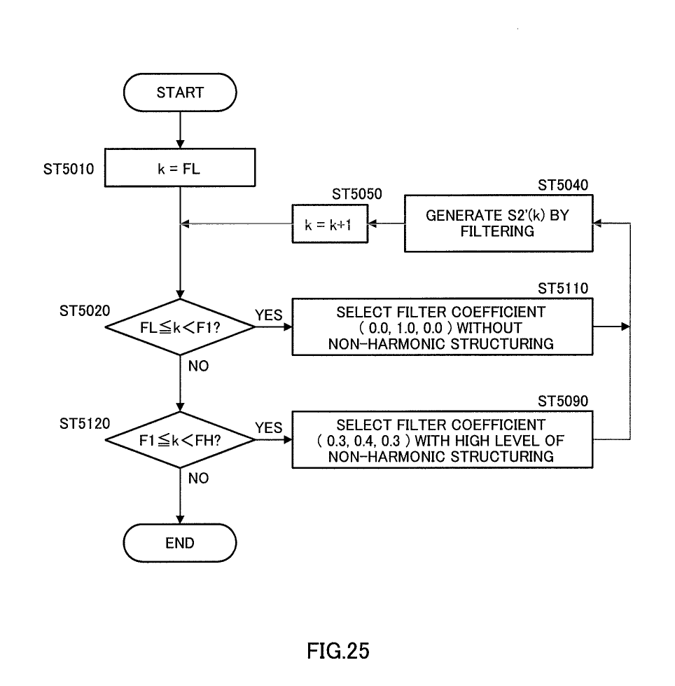

Further, FIG. 25 illustrates the flowchart of this processing. Unlike the setting in FIG. 21, the number of subbands is two, and, consequently, there are two steps of decision, ST5020 and ST5120. Further, the flow in ST5010, ST5020, etc., is the same as in FIG. 21, and therefore will be assigned the same reference numerals and explanations will be omitted.

In the event of “YES” in ST5020, second layer coding section 104e selects the filter coefficient that does not involve non-harmonic structuring (ST5110), and the flow proceeds to step ST5040.

In the event of “NO” in ST5020, whether or not the frequency k is included in the second subband, that is, whether or not the relationship F1≦k<FH holds, is decided (ST5120). In the event of “YES” in ST5120, the flow proceeds to ST5090 in which second layer coding section 104e selects the filter coefficient of the “high” level of non-harmonic structuring. In the event of “NO” in ST5120, the processing in second layer coding section 104e is finished.

Embodiments of the present invention have been explained above.

Further, the speech coding apparatus and speech decoding apparatus according to the present invention are not limited to above-described embodiments and can be implemented with various changes. Further, the present invention is applicable to a scalable configuration having two or more layers.

Further, the speech coding apparatus and speech decoding apparatus according to the present invention can equally employ configurations in which the higher band spectrum is encoded after the lower band spectrum is changed when there is little similarity between the spectrum shape of the lower band and the spectrum shape of the higher band.

Further, although cases have been described with the above embodiments where the higher band spectrum is generated based on the lower band spectrum, the present invention is not limited to this, and it is possible to employ a configuration in which the lower band spectrum is generated from the higher band spectrum. Further, in a case where the band is divided into three subbands or more, it is equally possible to employ a configuration in which the spectrums of two bands are generated from the spectrum of the other one band.

Further, as frequency transform, it is equally possible to use, for example, DFT (Discrete Fourier Transform), FFT (Fast Fourier Transform), DCT (Discrete Cosine Transform), MDCT (Modified Discrete Cosine Transform), and filter bank.

Further, an input signal of the speech coding apparatus according to the present invention may be an audio signal in addition to a speech signal. Further, the present invention may be applied to an LPC prediction residual signal instead of an input signal.

Further, although the speech decoding apparatus according to the present embodiment performs processing using encoded data generated in the speech coding apparatus according to the present embodiment, the present invention is not limited to this, and, if the encoded data is appropriately generated to include necessary parameters and data, the speech decoding apparatus can equally perform processing using the encoded data which is not generated in the speech coding apparatus according to the present embodiment.

Further, the speech coding apparatus and speech decoding apparatus according to the present invention can be included in a communication terminal apparatus and base station apparatus in mobile communication systems, so that it is possible to provide a communication terminal apparatus, base station apparatus and mobile communication systems having the same operational effect as above.

Although a case has been described with the above embodiments as an example where the present invention is implemented with hardware, the present invention can be implemented with software. For example, by describing the speech coding method according to the present invention in a programming language, storing this program in a memory and making the information processing section execute this program, it is possible to implement the same function as the speech coding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-124175, filed on Apr. 27, 2006, including the specification, drawings and abstract, is incorporated herein by reference in its entirety.

### INDUSTRIAL APPLICABILITY

The speech coding apparatus or the like according to the present invention is applicable to a communication terminal apparatus and base station apparatus in the mobile communication system.

1. A speech coding apparatus comprising:
a first coding section that encodes a lower band of an input signal and generates first encoded data;
a first decoding section that decodes the first encoded data and generates a first decoded signal;
a pitch filter that has a multitap configuration comprising a filter parameter for smoothing a harmonic structure; and
a second coding section that sets a filter state of the pitch filter based on a spectrum of the first decoded signal and generates second encoded data by encoding a higher band of the input signal using the pitch filter.

2. The speech coding apparatus according to claim 1, wherein the second coding section performs at least one of smoothing the harmonics structure and noise component assignment, for the higher band of the input spectrum.

3. The speech coding apparatus according to claim 1, wherein:
the filter parameter comprises filter coefficients; and
in the filter coefficients, there is a little difference between adjacent filter coefficients.

4. The speech coding apparatus according to claim 1, wherein the filter parameter comprises the number of taps equal to or greater than a predetermined number.

5. The speech coding apparatus according to claim 1, wherein the filter parameter comprises noise gain information equal to or greater than a threshold.

6. The speech coding apparatus according to claim 1, wherein:
the pitch filter comprises a plurality of filter parameter candidates for smoothing the harmonic structure at different levels; and
the second coding section selects one of the plurality of filter parameter candidates according to a noise level of at least one of a spectrum of the input signal and the spectrum of the first decoded signal.

7. The speech coding apparatus according to claim 1, wherein:
the pitch filter comprises a plurality of filter parameter candidates for smoothing the harmonic structure at different levels; and
the second coding section selects a filter parameter maximizing the similarity between the estimated spectrum generated by the pitch filter and the higher band of the spectrum of the input signal, from the plurality of filter parameter candidates.

8. The speech coding apparatus according to claim 7, wherein the similarity is calculated using a noise level of the spectrum of the input signal.

9. The speech coding apparatus according to claim 1, wherein:
the pitch filter comprises a plurality of filter parameter candidates for smoothing the harmonic structure at different levels; and
in the spectrum of the higher band of the input spectrum, the second coding section selects a filter parameter for smoothing the harmonic structure at a higher level when a frequency in the higher band of the spectrum increases, from the plurality of filter parameter candidates.

10. A speech decoding apparatus comprising:
a first decoding section that decodes first encoded data and acquires a first decoded signal comprising a lower band of a speech signal;
a pitch filter that has a multitap configuration comprising a filter parameter for smoothing a harmonic structure; and
a second decoding section that sets a filter state of the pitch filter based on a spectrum of the first decoded signal and acquires a second decoded signal which is a higher band of the speech signal by decoding second encoded data using the pitch filter.

11. A speech coding method comprising the steps of:
encoding a lower band of an input signal and generating first encoded data;
decoding the first encoded data and generating a first decoded signal;
setting a filter state of a pitch filter that has a multi-tap configuration comprising a filter parameter for smoothing a harmonic structure, based on a spectrum of the first decoded signal; and
generating second encoded data by encoding a higher band of the input signal using the pitch filter.

12. A speech decoding method comprising:
decoding a first encoded data and acquiring a first decoded signal comprising a lower band of a speech signal;
setting a pitch filter that has a multitap configuration comprising a filter parameter for smoothing a harmonic structure, based on a spectrum of the first decoded signal; and
acquiring a second decoded signal comprising a higher band of the speech signal by decoding second encoded data using the pitch filter.
